(19) United States
(12) Patent Application Publication
(10) Pub. No.: US 2010/0257474 A1
(43) Pub. Date: Oct. 7, 2010

(54) METHOD ENABLING A COMPUTER APPARATUS RUN BY AN OPERATING SYSTEM TO EXECUTE SOFTWARE MODULES

(76) Inventors: Francois BOCHATAY, Vufflens-Le-Chateau (CH); Vincent Rithner, Monthey (CH)

Correspondence Address: BLANK ROME LLP, WATERGATE, 600 NEW HAMPSHIRE AVENUE, N.W., WASHINGTON, DC, 20037, US

(21) Appl. No.: 12/780,195

(22) Filed: May 14, 2010

Related U.S. Application Data
(63) Continuation of application No. PCT/EP2008/065526, filed on Nov. 14, 2008.

(30) Foreign Application Priority Data
Nov. 15, 2007 (CH) 01765/07

(51) Int. Cl. G06F 9/44; G06F 15/16; G06F 3/048; G06F 9/445

(52) U.S. Cl. 715/769; 717/120; 709/248; 715/788; 717/178

(57) ABSTRACT

Method enabling a computer apparatus (1) run by an operating system (11) to execute and configure software modules (14, 15). The operating system (11) starting a middleware (12) to execute and manage said software modules (14, 15). A user configures the middleware (12), so as to define simultaneously the graphical aspect of said software modules (14, 15). The system synchronizes with a remote server (3) to allow the user to obtain the same graphical interface when the software modules (14, 15) are executed on another computer apparatus.

### TECHNICAL FIELD

The present invention concerns a method enabling a computer apparatus run by an operating system to execute and configure software modules.

### DESCRIPTION OF RELATED ART

The conventional software architecture of computer systems uses an operating system over the lower layers of the protocol. The operating system is responsible for ensuring the connection between the material resources of the computer system and the user's software applications. Windows, Windows Vista, Mac OS X, Unix, different variants of Linux, Symbian, etc. constitute known examples of operating systems.

An operating system is generally composed of a core, of libraries, of a set of system tools and often of basic application programs. The core ensures notably the management of the peripheral, of the memory, of the folders, of the network protocols and of the different processes. The libraries serve to regroup frequent operations used by different programs.

The system tools include most often a graphical interface that makes it easier to use the computer apparatus. Many operating systems include a graphical interface based on windows. Each computer application is generally executed in its own window that can be moved or re-dimensioned over a desktop that occupies the whole screen and regroups all the windows. The operating system manages the memory space allocated at each moment to each application and handles the external appearance and the movements of the windows. The contents displayed in each window are however left up to the application. It is difficult to modify simultaneously the appearance inside the different windows.

Widget engines are furthermore known, i.e. software designed to display on the desktop of an operating system, or in the window of a web browser, small applications called widgets, screenlets or gadgets according to the platform. Hereinafter, the designation widget will be used generically. Widgets allow simple tasks to be performed or various information such as the weather, the stockmarket, the current time etc. to be displayed. Only relatively simple software can be executed by widget engines; a more complex application, for example a sophisticated text processing or an advanced web navigator cannot generally be executed efficiently and reliably as a widget.

Many nomad users use different computers, for example at home, at work, when traveling etc. For this purpose, online application programs are known that allow access and editing of a document from different locations. The program's data are stored on a remote server so that the user does not need to save them or take them when moving around. The company Google offers for example text processing and a spreadsheet that can be accessed at a distance from the website www.google.com.

The remote executing of an application as well as writing and reading access to all the data through a computer network such as Internet will however slow down the application, which is detrimental to its ergonomics and prevents work when no connection is available. Finally, remote applications are most often executed in a navigator, possibly with the aid of Java applets, JavaScripts or of a plug-in such as Macromedia Flash; these applications only have access to a limited set of graphical commands for displaying and animating objects on the screen, which makes the programming of modern and user-friendly interfaces difficult.

One also knows WebOS, i.e. operating systems on the web that allow a page to be displayed in a navigator imitating the graphical environment of an operating system. eyeOS is an example of such an environment, which enables a user to access his office, his files and his eyeOS applications from any navigator and on any computer. WebOS suffer from the same problems of slowness and limitations of the graphical interface as applications accessible at a distance.

There are furthermore many examples of applications that can be executed either locally on the user's computer apparatus or remotely by accessing data stored on a remote server. Many e-mail clients or diary managers make it possible for instance to access the user's data either from a local client or over a web interface. Synchronization modules allow local data and those on the remote server to be updated so as to reflect the changes made from one or the other interface. Such solutions, however, do not allow data originating from a large number of different applications to be simply updated.

Furthermore, the prior art operating systems do not enable the graphical appearance of all the executed applications to be modified easily. The application programmers are practically free to use the graphical space at their disposal inside the windows as they see fit, and only very limited interventions can be carried out to act simultaneously on the contents of several windows of different applications. The result is often very heterogeneous interfaces, with different applications using colors, graphical codes, symbols, an ergonomics and a navigating system that are often completely different from one another.

Examples of prior art documents relating to the general subject of the invention include:

1) WO-A-99/57862,

2) “WALK-UP-AND PERSONALIZE WORKSTATION SERVICE” IBM TECHNICAL DISCLOSURE BULLETIN, IBM CORP. NEW YORK, US, vol. 37, no. 3, Mar. 1, 1994 (1994-03-01), page 581, ISSN: 0018-8689, and

3) “STORAGE OF USER PREFERENCES ON A PER-USER 1-19, BASIS”, IBM TECHNICAL DISCLOSURE BULLETIN, IBM .CORP. NEW YORK, US, voL. 36, no. 1, Jan. 1, 1993 (1993-01-01), page 64, ISSN: 0018-8689

### BRIEF SUMMARY OF THE INVENTION

One aim of the present invention is to propose a method free from the limitations of the prior art.

Another aim of the invention is to propose a method enabling a user to combine the advantages of applications executed locally (speed, advanced graphical interface, data available even without remote connection) with the advantages of applications executed remotely (access to one's data from different locations and different computers, etc.).

According to the invention, these aims are achieved notably by a method enabling a computer apparatus run by an operating system to execute and configure software modules, with:

said operating system starting a middleware (mediator software) to execute and manage said software modules,

a user configuring said middleware, so as to define simultaneously the graphical aspect of said software modules,

synchronizing with a remote server to allow said user to obtain the same graphical interface when said software modules are executed on another computer apparatus.

The mediator software (middleware) thus constitutes a federating element allowing different modules developed independently to share features, to communicate with one another and to exchange data with one another.

This method notably has the advantage over the prior art that the graphical aspect of many software modules is managed with a single middleware executed over the operating system. It is thus possible to modify the look and feel of different modules, or even of all the modules, with a single operation. In a preferred embodiment, the graphical aspect of different modules executed in different processes can be modified in a single operation, the modification going beyond the window frame or the fonts used.

This method further allows the graphical parameters selected locally to be synchronized with the graphical parameters used when these modules are executed remotely on a server.

This method also has the advantage of synchronizing a plurality of software modules locally and remotely, with the aid of synchronization tools made available to all the modules by a single middleware.

The middleware thus constitutes a sort of “meta operating system” installed over an existing operating system and providing the computer developers with an interface that allows them to develop more quickly software modules with a graphical interface and functionalities that are harmonized. The middleware takes over aspects of the programming, notably the advanced management of the graphical aspect inside the windows, the security, the collaborating tools etc. that are usually neglected by the current operating systems and managed by the different applications. Furthermore, different versions of the middleware can be developed for different operating systems, which allows a developer of software module to develop a single module that can be directly executed on several types of machines using different operating systems or at least different variants of an operating system, for example Windows XP and Windows Vista.

### BRIEF DESCRIPTION OF THE FIGURES

Examples of embodiments of the invention are indicated in the description illustrated by the attached figures in which:

FIG. 1 illustrates diagrammatically and in simplified manner the system of the invention.

FIG. 2 illustrates an example of data displayed by the middleware of the invention on a computer apparatus.

FIG. 3 illustrates another example of data displayed by the middleware of the invention on a computer apparatus.

### DETAILED DESCRIPTION OF THE INVENTION

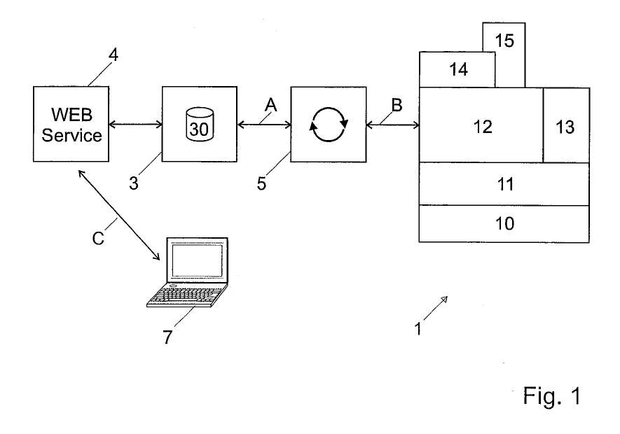

FIG. 1 illustrates diagrammatically and in simplified manner the system of the invention. The system comprises a central server 3 to which a plurality of local users 1 and a plurality of remote users 7 connect themselves. In this application, the term “central server” is not restricted to a single machine, but should be interpreted so as to include as well sets of interconnected machines, including service clouds, i.e. systems where data and application are stored and executed by a plurality of computing systems in the Internet. The central server 3 can be thus be constituted of a single monolithic machine or comprise one or several machines connected to one another and/or connected to Internet or to a local network of the type LAN.

Further, in this application, the term “local users 1” designates users 1 that use a certain number of software modules executed locally by their own computer apparatus, for example in their personal computer, their PDA, their mobile phone, etc. A local user can however perfectly well use one or several software modules that connect remotely with the server 3 (for example a cloud) or with other servers to access certain parameters or data. The expression “remote user” on the other hand designates users that use software modules executed on the server 3 (such as the cloud), or on any other server, and that display results presented for example in a navigator or on a communication terminal on the apparatus 7.

The central server or servers include one or several databases 30 made available to several users; the databases can themselves comprise one or several tables stored on one or several machines. The databases may also be dynamic databases. The database 30 includes, for each affiliated user, for example the following indications:
Data of the user: name or alias, password, etc.
List of software modules installed on his computer apparatus
Parameters allowing the graphical aspect of all the software modules to be defined
Personal preferences of the users' in relation to one or all of the software modules
User data for each of said software modules
Backup of the users' data, in order for example to perform an automatic save in the background of all the data
Information and message shared with other users.
Etc.

The server 3 (for example a cloud) preferably further comprises software (not represented) for executing the following services or functions:
Authenticating the users connected remotely;
Making available the software modules, the data and the parameters that are to be downloaded and/or synchronized with the middleware of the remote users;
Executing with the aid of web services 4 the software modules to which the remote users wish to connect;
Executing with the aid of web services 4 the software modules and transmitting the data computed by said software modules so as to cause the results to be displayed on navigators or communication software of remote users.

These additional services can for example be made available by one or several dotnet or Java applications or any other application of server type executed by the server 3 and made available to the remote users over an Internet address in the form of web services 4. The data made available can come from the server 3 or from third party servers for example on Internet.

The server 3 can also comprise a download platform enabling remote users 7 to download new software modules that can be executed by the middleware. The database 30 is automatically updated as soon as a new software program has been downloaded and installed. An optional billing module allows the downloading or the activating of software modules to be billed.

The computer apparatus of the user 1 is for example constituted by a personal computer, a workstation, a PDA, a mobile phone, etc. It comprises a protocol stack with conventional protocol low layers 10, defining for example the used material, the bios etc. An operating system 11 makes it possible to access the material resources; the operating system preferably further includes a graphical interface managing windows, scroll menus etc. The operating system can be constituted by a conventional operating system of the type Windows, Mac OS X, Linux, Symbian, etc.

A plurality of applications 12, 13 can be executed directly over the operating system, for example a text processing application, a database, a web navigator, a widget engine etc. According to the invention, one of these applications executed by the operating system is a mediator software (middleware) 12. The middleware 12 constitutes a platform with its own graphical interface enabling software modules, for example applications 14 and widgets 15, to be executed over the middleware 12, with a graphical interface, an ergonomics and a “look and feel” common to all the modules. The middleware is executed either in a window, or directly on the desktop of the operating system 11. It is possible to re-dimension it (if it occupies a window) or to re-dimension its individual elements (if it is on the desktop). In any case, it is possible to minimize or hide it.

The middleware 12 makes available to modules 14, 15 routines library allowing the developers of new modules to access the resources of the computer apparatus and of the operating system 11. The library made available comprises notably for example:
Graphical routines for accessing the display of the user's computer apparatus, notably routines for generating and moving windows in the graphical space managed by the software module 12, routines for managing other graphical interface elements such as scroll menus, scroll bars, dialog boxes etc., routines for displaying text, drawing routines, etc. The graphical routines preferably allow a vectorial representation of all the windows and of the graphical space managed by the software module 12. The windows generated with the aid of these routines can thus be moved or re-dimensioned with the aid of appropriate functions of the middleware 12, quickly and without quality losses. The graphical routines made available by the middleware 12 preferably offer access to all the graphical abilities of modern personal computers, including a 2D and/or 3D graphics, video and animated image management, etc.
System routines for accessing material resources of the computer apparatus, for example for managing files of the operating system 11, for writing on discs or modifying the permanent memory, for accessing networks, etc. The middleware preferably grants access only to a subset of the repertories or files of the operating system 11, this being under predefined security conditions in order to avoid any possibility of creating modules of the virus, spy or dangerous type that could jeopardize the durability of the system.
Routines allowing the authentication and identification of the users to be handled. In a preferred embodiment, the users must be authenticated in order to launch the middleware, to synchronize with the remote server and for downloading new software modules or new pages. A single identification can be performed for these different purposes. This identification can furthermore be transmitted to the different softwared modules, in order to administrate rights depending on the users. In one embodiment, the middleware uses the user's domaine identification performed by the user 1 when he launches the operating system 11 or when he connects his computer to a domain.
Routines for synchronizing the data and the parameters of the different modules with the corresponding data and parameters on the remote server 3 (such as a cloud). In a preferred embodiment, this synchronization is performed by the middleware 12, automatically, in the background and without the programmer of a module 14, 15 having to specifically program this synchronization. Priorities can be allocated to the different synchronization tasks, by default by the system and/or manually by the user, high priority synchronization tasks being performed before low priority synchronization tasks. A user can for example chose to synchronize text files generated by a first software module before or more frequently that the image files generated by another software module.

The software module executed by the middleware 12 can comprise simple widgets 15, for example widgets for displaying the time, the stockmarket, information from the state of the computer system, from Internet or from a database, etc. These widgets are activated by the middleware and displayed directly on the desktop managed by the software or in a navigator or in the window of the middleware, using the graphical routines made available by this middleware, so that all the widgets thus exhibit a comparable visual aspect and ergonomics.

The modules executed by the middleware 12 can however also comprise more complex applications, including for example a web navigator, an e-mail client, a RSS (Really Simple Syndication) feed, share and communication tools, a text processor, a spreadsheet, an image and photo manager, etc.

The middleware preferably includes basic application programs, including share programs for handling communications, e-mails and instant messaging with interlocutors and members of the communities shared by the user. Basic application programs, notably share programs, preferably offer tools accessible to all the software modules 14, 15, for example for exchanging or publishing easily data from different modules. The share program allows for example one user to manage a list of friends or partners, to add or delete friends, to allocate them rights, to send them or synchronize data coming from any module, for example text, images, etc., for example in the form of e-mails or of an instant messaging message, and/or to send them complete software modules that will be used and installed immediately at the recipient's.

The middleware 12 can also include an electronic payment module that is preinstalled or in the form of web services offering payment functionalities to all the other modules. The payments from any application or software running on the middleware can then use this module's identification and electronic payment functionalities.

As mentioned, the system preferably comprises a synchronization module 5 for handling the data synchronization between the middleware 12 and the remote server 3. The synchronization can be installed physically in the apparatus of the user 1, or in the remote server 3, or in an intermediary machine. It is also possible to use a synchronization module composed of different elements distributed on the server 3, on the computer apparatus 1 and possibly on one or several additional machines, for example a synchronization server on Internet.

A plurality of remote users 7 access the software modules and their corresponding data online, for example over Internet or using a cellphone. For this purpose, the users preferably connect with the aid of a conventional web navigator that allows them to display, after having been authenticated, a web page, accessible at a predefined URL address, with a graphical aspect corresponding at least along general lines to the window displayed by the middleware 12 on the computer apparatus 1. The remote users 7 thus find in their navigator a familiar work environment, including a desktop organized in an identical manner, with the same software modules at their disposal, module windows arranged in the same manner, an identical graphical interface, and access to the same data and same user preferences. The synchronization between the server 3 and the apparatus 1 thus notably implies continuously updating the user parameters, of the data, of the graphical preferences, of the list of modules, etc.

Each software module of the user thus exists in two versions, i.e. a local version executed by the apparatus of the user 1 over the middleware 12, and a remote version executed by the server 3 and accessible over a telecommunications network, for example through an Internet type network and a navigator or another communication software. In a preferred embodiment, the software modules are programmed with the .NET technology of Microsoft. The middleware can preferably be used and installed with the ClickOnce technology, or in the form of an executable installation file, on the user apparatus that have the prerequisite .net framework. The .net framework can also be used at the same time as the application. Other technologies can also be used for this purpose.

Each used software module is executed by the apparatus 1 in the same security context as a web application, which protects the computer apparatus from use of malicious modules or from the user's handling errors. An additional protection is ensured by programming software modules that access the computer's resources, notably the permanent memory, only through corresponding routines of the middleware 12 that offers additional security. Security mechanisms can be implemented to forbid the use or execution of software modules that would try to access directly the system resources without using the middleware's routines.

Software modules are preferably programmed with the WPF or Silverlight programming module, or other technologies including Adobe's programming technologies and tools. A version of the module can be executed as Xaml (.xbap) application, as Java or Javascript applet and is designed to be presented by the server 3 and accessed through a navigator.

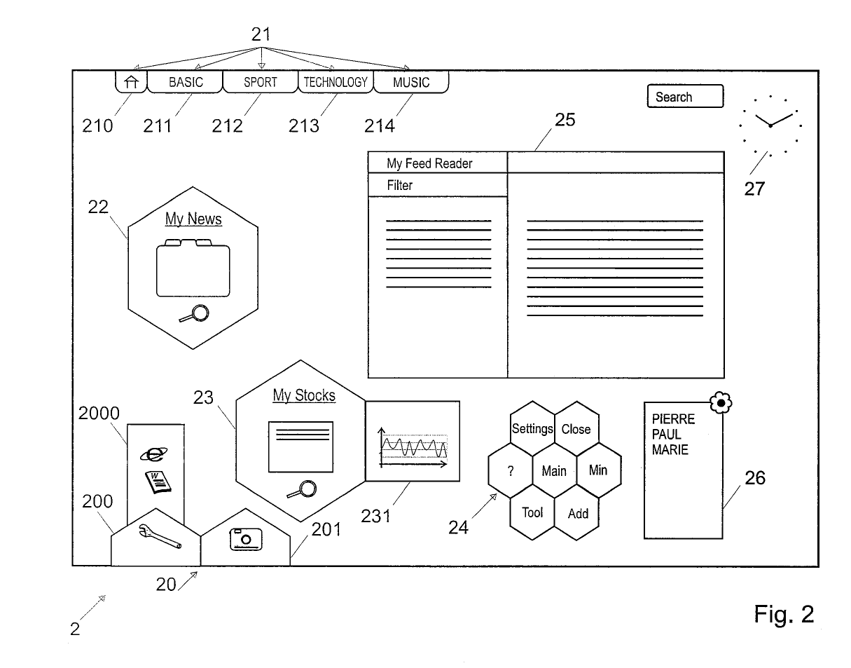

FIG. 2 illustrates an example of desktop 2 displayed with the aid of the inventive method. This desktop can be displayed either in the window or the graphical space made available to the software 12 by the operating system 11, or by a navigator in the case of a remote access by a remote user 7.

The desktop 2 comprises in this non-limiting example a zone 20 for launching software modules.

Adding modules can preferably be done by calling up a function “add” of the main menu 24. Once this module has been loaded, it is possible to place it or to minimize it in the zone 20. The module thus placed or minimized retains its preferences and data and can be called up at any time. Furthermore, this zone 20 could in one embodiment make it possible to place the other shortcuts on the desktop (for example shortcuts to third party applications which can be launched from here). One mouse click on the icon 200 causes its contents to be displayed. One mouse click on the shortcut launches the application or calls up the module on the desktop.

The minimized or reduced software modules are preferably organized in different files, including in this example a file 200 comprising a utilities list and another file 201 comprising a list of minimized modules. By selecting one of the file icons, for example with a mouse click on the icon 200, the user causes the file's contents to be displayed in a tab 2000, in order to display the list of modules in each file. The tab preferably automatically returns to its masked position after a few instants of inactivity.

In the illustrated embodiment, the files are represented by graphical icons displayed in windows 200, 201 that have a hexagonal shape in the specific example of this topic; the tab 2000 will spread like a rectangle from one or several sides of the hexagon, and includes in this example two icons of software modules, corresponding here to a text processor and to a web navigator executed on the desktop 2. In an embodiment, hexagonal windows make it possible to spread either horizontal extensions, from one of the vertical sides of the hexagon as in the case of window 23, or vertical extensions spread from the upper or lower tip of the window. Furthermore, the hexagonal windows can also comprise control buttons on the back or on/close to the frame of the window, to perform actions.

In another preferred embodiment, a ribbon is used instead of hexagonal windows.

The desktop 2 may comprise several “pages” allowing the user to organize the displayed windows. In this example, the different pages can be accessed with the aid of tab 21 on the top of the desktop, in the manner of a virtual card index; the user thus has the impression of navigating between desktops stacked on one another. The different pages of the desktop can be organized with a single hierarchical level, as in the illustrated example; it is then always possible to move from any page of the desktop to any other one by selecting the corresponding tab. In a variant embodiment, the different pages are organized hierarchically, with an arborescence making it possible to move from one page to “parent” or “child” pages.

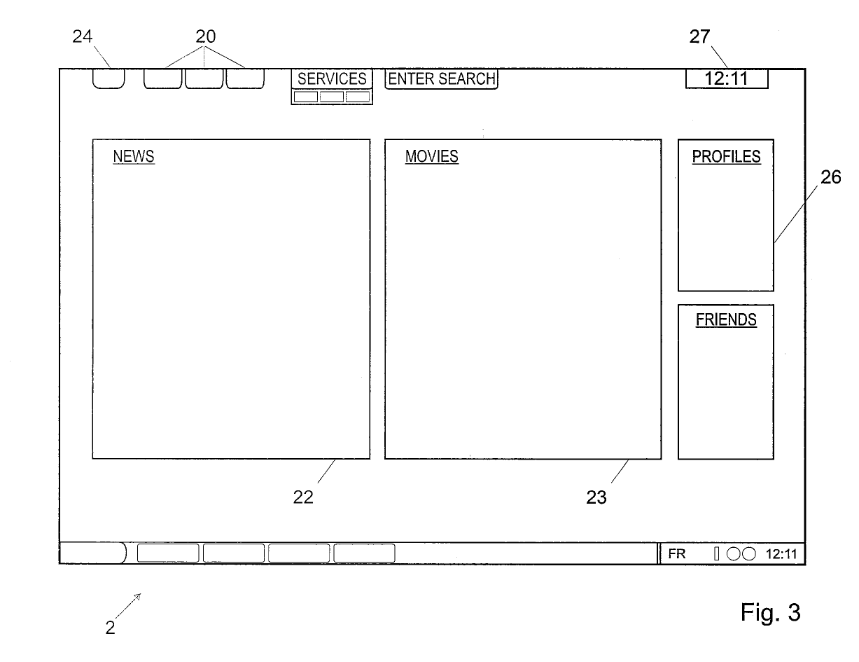

Other modes of representation, including pages represented on the different sides of a cube, etc., are also conceivable. In the embodiment of FIG. 3, a window replaces the above described concept of page. Each window which is displayed in the area 2 used by the middleware comprises one or several widgets (user controls). For example, a single window that may be loaded and displayed may include several widgets relating to a common topic, for example several areas for displaying text, images and video from one or several sources, and for interacting with this data.

The user may load a pre-defined window, or build its own window based on predefined templates and by defining parameters of the user controls. Each user may also publish a page he has created and makes it available for his community or for other users. In one embodiment, a share button is associated with at least some windows. The user who clicks on this button gets a dialog box from which he can see a list of other users or groups which he can select for sharing the window.

The desktop illustrated on FIG. 2 comprises 5 superimposed pages regrouping software modules for the home (desktop 210), the basic modules (211), those for sports (212), technology (213) and music (214). Other pages of the desktop can preferably be added, renamed, moved or removed freely by the user, who also has the possibility of defining the applications executed on each page. The middleware can also control the processing time allocated to each page, so as for example to allocate a higher priority to the software modules displaying a result on the page currently visualized in the foreground.

FIG. 3 illustrates another example of desktop using ribbon technology instead of hexagonal windows. On this example, two windows 22, 23 are open; one window contains news while the other one shows information relating to movies. Other windows have been reduced in the area 20, for example one window about soccer and the other about technology.

In a preferred embodiment of the invention, the user can install new windows directly from the server 3 using an add function accessible with a corresponding widget on the interface. He then receives a window that is immediately populated with modules corresponding to the page's topic. It is for example possible to create and distribute windows corresponding to events, for example to sports or cultural events, and to populate these pages with a set of adapted modules, for example a widget displaying the countdown until the beginning of the event, news relating to the event, photos and videos, live sports results, the weather forecast and the television program associated to the event, e-commerce modules allowing tickets to be bought, etc. Other windows can be proposed by manufacturers of electronic peripherals and include modules for installing and using the peripheral easily; a manufacturer of webcams could for instance include a window with a module making it easier to install material, a module for displaying the user manual, another module for using the webcam and communicate with one's interlocutors, etc.

It is also possible to finance the distribution of software modules with the aid of other modules automatically installed on the same page and displaying for example advertisements. The installation of a complete window or of a set of linked computer software can preferably be associated to the installation of an additional topic defining the interface's graphical and/or sound characteristics.

The computer software 14, 15 are preferably executed in windows on the desktop 2; the middleware 12 manages these different windows, including the window allocated to each application, the appearance, the size and position off this window, the choice of the active window at each instant, etc. The appearance of the different windows can preferably be configured with the aid of a configuration computer software allowing the appearance of several, or even of all the windows on the desktop 2 or on one of the pages of the desktop 2 to be modified simultaneously. The graphical parameters of the windows that can be configured preferably include for example the following aspects: shape, background shading, text color, color of the border, font, shape of the horizontal and vertical scroll bars, graphics of the border, background and/or sounds associated to different events, etc. The size and dimension of the different windows can however be configured individually for each window.

The common graphical parameters applied to the different windows are preferably regrouped in the form of topics or skins; the user can chose, from among a list of predefined topics, the choices that apply immediately to all of the software modules on the desktop, or at least to all of the modules on the active page of the desktop. Limited customizing possibilities allow each user to modify each topic according to his own preferences; however, in order to avoid unaesthetic or poorly ergonomic interfaces, the middleware 12 prevents certain manual modifications that could be performed only by changing the topic completely. It would for example be conceivable to restrict the range of colors available according to the topic, a topic called arctic excluding for example the red and the other hot or too bright colors.

In the illustrated example, at least some windows 22, 23, 24 have a hexagonal shape with a window heading in the upper tip portion, menu buttons above the title that are displayed when the cursor passes over any area on the window, control buttons in the lower tip and an approximately rectangular display zone towards the center, this central zone being left free for the external developer. A rectangular extension 231 can extend from one border of some windows 23. The graphical interface then preferably comprises a command allowing the different windows to be dimensioned automatically to give them the same dimension, and possibly for juxtaposing them in the manner of a honeycomb. It is however perfectly possible to replace this hexagonal window shape by rectangular or other windows, simply by changing the graphical parameters of the topic or by changing the topic.

The windows 25 that require a great surface to display longer contents are displayed in an approximately rectangular frame. Other modules 27 can have a transparent frame and background so that the shape of the window seems indeterminate.

The graphical interface further comprises buttons 24 simply placed on the desktop and that grant access to the main menu managing the middleware. In the embodiment of FIG. 3, the interface comprises a ribbon for this purpose. The functions of this menu apply to all the platform, for example for closing it, minimizing it, managing the users' preferences, changing the topic, etc.

The middleware preferably further comprises a search tool, accessible for example with the “search” button on the desktop, in order to search for text data, images, messages etc. of all the installed software modules or from the web. The search is thus limited to the many modules running on the middleware or can include a search among the data on the web, in the computer, on an Intranet, etc. The search results are preferably displayed in a window executed above the middleware and enabling the search results to be displayed in the form of a text, of lists of images, of RSS feeds, etc.

The graphical interface makes it possible preferably to perform actions simply by dragging and dropping windows on one another. For example, sending data from one of the open applications can be carried out simply by selecting the window whose current contents must be sent, then by depositing this window on the name of an interlocutor in the interlocutor list 26. In a variant embodiment, the middleware proposes one or several “share zones”, i.e. an area in which the data can be placed before being sent or shared with another user.

The invention also concerns a computer data carrier containing a program designed to be executed by a computer apparatus 1 or 3 for executing the method described here above. The present invention concerns in particular a computer data carrier comprising a middleware of the type described here above, notably a middleware designed to be executed by a computer apparatus capable of being configured so as to define simultaneously the graphical aspect of said software modules, said middleware further allowing a synchronization with a remote server in order to allow said user to obtain the same graphical interface when said software modules are executed on another computer apparatus. The present invention also concerns computer carriers comprising software modules such as described here above, notably software modules that can be executed on a middleware, whose aspect can be redefined by a middleware and/or using share tools of the middleware.

### REFERENCE NUMBERS USED ON THE FIGURES

1 Offline or locally operating computer apparatus
10 Low layers of the protocol stack
11 Operating system
12 Mediator software (middleware)
13 Applications executed directly by the operating system
14 Module executed by the middleware
15 Widgets executed by the middleware
2 Example of desktop displayed by the middleware
20 Zone where the modules are placed
200 Zone where the utility modules or the shortcuts towards third party applications are placed
2000 Tab with the list of positioned utility modules or of shortcuts to third party applications
21 Tabs granting access to different desktops of the middleware
210 Main desktop, preferably the only one that cannot be removed
211 Desktop dedicated to the basic modules (example)
212 Desktop dedicated to sports (example)
213 Desktop dedicated to technology (example)
214 Desktop dedicated to music (example)
22 News module executed by the middleware
23 Other module executed by the middleware
231 Window extension spread from the financial module
24 Main menu buttons of the middleware
25 Application module executed by the middleware
26 List of interlocutors-community module with list of “my friends” and possibility of regrouping friends, display of friend's status (online/offline), etc.
27 Widget executed by the middleware
3 Server
30 Database
4 Web service
5 Synchronization module
7 Online computer apparatus
A Connection of server to synchronization module (for example Internet)
B Connection between the computer apparatus 1 and the synchronization module (for example via Internet)
C Connection between the computer apparatus 7 and the web services made available by the server 3

1. A method enabling a computer apparatus run by an operating system to execute and configure software modules, with:
said operating system starting a middleware to execute and manage said software modules,
a user configuring said middleware, so as to define simultaneously the graphical aspect of said software modules,
synchronizing said computer apparatus with a remote server to allow said user to obtain the same graphical interface when said software modules are executed on another computer apparatus.

2. The method of claim 1, comprising a step of synchronizing the data executed by said software modules between said remote server and said computer apparatus.

3. The method of claim 1, wherein said user is identified vis-à-vis said middleware,
wherein a list of software modules installed at each user is stored in said remote server,
wherein said list is updated when said user installs or removes a software module in his computer apparatus,
wherein data and/or parameters belonging to each said software module and to each user are synchronized between said central server and said computer apparatus.

4. The method of claim 1, wherein said synchronization is performed as background task during use of said software modules.

5. The method of claim 1, comprising a step during which priorities are allocated to different synchronization tasks, the high priority synchronization tasks being performed before the low priority synchronization tasks.

6. The method of claim 1, wherein said middleware makes available to said software modules a routines library, including graphical routines for accessing the screen of said apparatus, and routines for accessing material resources of said apparatus,
and wherein said software modules access said screen only by using said routines.

7. The method of claim 1, wherein said middleware makes available to said software modules a routines library, including routines for modifying the permanent memory of said apparatus,
and wherein said modules write in said permanent memory only by using said routines.

8. The method of claim 1, comprising a step during which said user executes one said remote software module on said server from a navigator in a computer apparatus.

9. The method of claim 1, wherein said middleware manages a system of windows in which said software modules are executed,
the aspect and/or the shape of said windows being configured by said user by modifying parameters of said middleware.

10. The method of claim 9, wherein certain windows have a hexagonal shape.

11. The method of claim 1, wherein said middleware manages a desktop with several pages or windows.

12. The method of claim 1, wherein said middleware manages a system of windows with contents displayed in the form of vectorial graphics of which all elements can be re-dimensioned.

13. The method of claim 1, wherein
said middleware displays a list of other users and manages communication and/or sharing functions with said other users,
where data of said software modules can be transmitted to said other users by “dragging and dropping” onto said other users or over a sharing button.

14. The method of claim 1, wherein said software modules comprise both applications and widgets.

15. The method of claim 1, wherein said software modules comprise a navigator executed over said middleware.

16. The method of claim 1, comprising a step of installing one additional said software module with the aid of the following steps:
selecting said software module;
downloading said software module from said remote server;
installing said software module in said computer apparatus;
updating in said remote server a list of software modules installed in said computer apparatus.

17. The method of claim 1, comprising a step of downloading a complete window comprising a set of software modules that can be executed by said middleware.

18. The method of claim 1, said remote server being a service cloud in which the parameters defining said graphical aspect is stored.

19. A computer data carrier comprising a computer program designed to be executed by a computer apparatus for executing a middleware capable of being configured so as to define simultaneously the graphical aspect of said software modules, said middleware also allowing synchronization with a remote server in order to allow said user to obtain the same graphical interface when said software modules are executed on another computer apparatus.

20. A computer data carrier comprising a computer program designed to be executed by a computer apparatus for executing a software module whose aspect can be redefined by a middleware.
